(19) United States
(12) Patent Application Publication
(10) Pub. No.: US 2018/0055082 A1
(43) Pub. Date: Mar. 1, 2018

(54) PLANT AND HIGH PROTEIN FOOD PRODUCT

(71) Applicant: THE HERSHEY COMPANY, Hershey, PA (US)

(72) Inventors: Malathy NAIR, Hummelstown, PA (US); Heather M. ARNETZ, Hummelstown, PA (US); Stephen James CROZIER, Hummelstown, PA (US); Susan LEVAN, Palmyra, PA (US); Prashant MUDGAL, Harrisburg, PA (US)

(21) Appl. No.: 15/565,269

(22) PCT Filed: Apr. 15, 2016
(86) PCT No.: PCT/US2016/027793

§ 371 Date: Oct. 9, 2017

Related U.S. Application Data
(60) Provisional application No. 62/147,679, filed on Apr. 15, 2015.

(51) Int. Cl. A23L 33/105; A23L 2/02; A23L 2/56; A23L 2/66; A23L 19/00; A23L 33/17

(52) U.S. Cl. CPC A23L 33/105; A23L 2/02; A23L 2/56; A23V 2002/00; A23L 19/09; A23L 33/17; A23L 2/66

(57) ABSTRACT

A method of manufacturing a combined protein and plant food product includes hydrating at least one pectin source to form a pectin hydrate, hydrating at least one protein source to form a protein hydrate, and mixing the pectin hydrate with the protein hydrate to form a combined hydrate. The method further includes adjusting, if necessary, the pH of the combined hydrate to the range of 3.7 to 4.4. The method also includes homogenizing the combined hydrate to form a homogenized hydrate and adding at least one edible plant source to the homogenized hydrate to form the combined protein and plant food product. A combined protein and plant food product includes at least one edible fruit or vegetable plant source and at least one protein source mixed with the edible fruit or vegetable plant source. The protein and plant product is in a fluid form for consumption directly from a pouch.

### CROSS-REFERENCE TO RELATED APPLICATIONS

This application claims priority to and the benefit of U.S. Provisional Application No. 62/147,679 filed Apr. 15, 2015, which is hereby incorporated by reference in its entirety.

### FIELD

This application is directed to a comestible product and a method of making the same. More particularly, the present application is directed to a squeezable food product that is a combination of protein and plant elements (e.g., fruits, vegetables, and/or grains).

### BACKGROUND

Consumers often look for snacks and other comestible products that are, or are perceived to be, a healthier alternative and which often include fruit. Known comestible fruit products often contain mainly sugar, corn syrup, starch, a hydrocolloid or gelling agent, flavor, color, and acid. Recently, more “natural” or healthy versions have emerged containing a new range of ingredients, including fruit purees and fruit concentrates to substitute for the typical corn syrup and sugar. However, even among the more recent options, it is unknown to provide a combination of fruit-rich (concentrated) ingredients and a protein-rich (concentrated, isolated, enriched) ingredient, which presents a host of difficulties, particularly when attempting to form a squeezable snack delivering both fruit and protein benefits in a single serving.

One difficulty associated with the production of fruit and protein combinations is the ability to add protein to an acidic product. Many fruits are naturally acidic, and the formation of fruit purees and fruit concentrates only increases the acidity of the fruit product. When the protein is added to the acidic fruit concentrate or fruit puree, the combination of acid and heat during processing denatures the protein, forming a food product which is neither stable nor desirable. More specifically, this denaturing in an acidic environment may lead to formation of large protein aggregates, causing an unpleasant gritty or chalky consistency in the final fluid product.

Another difficulty associated with the production of plant and protein combinations is the heat involved in the production of a shelf-stable liquid product, along with the highly acidic environment (pH of 4.2 or less) used in hot fill production methods. With adding protein to acidic environments, the exposure of protein to high heat during cooking denatures the protein, particularly in the presence of high acid levels used in the hot fill process.

Several fruit purees currently are found in the market primarily in the baby food aisle that are shelf-stable with high acid, pH less than 4.2. However, these products are low in protein. On the other hand, several high-protein gelled products exist in pouches that focus on the athletic consumer with protein levels in excess of 15 grams (g) per serving. There are also fruit purees that have been recently introduced to the market with additions such as chia seeds or grains such as oats, but these products are not organoleptically acceptable.

### SUMMARY

In an exemplary embodiment, a method of manufacturing a combined protein and plant food product includes hydrating at least one pectin source to form a pectin hydrate, hydrating at least one protein source to form a protein hydrate, mixing the pectin hydrate with the protein hydrate to form a combined hydrate, adjusting, if necessary, a pH of the combined hydrate to the range of 3.7 to 4.4, homogenizing the combined hydrate to form a homogenized hydrate, and adding at least one edible plant source to the homogenized hydrate to form the combined protein and plant food product.

In another exemplary embodiment, a combined protein and plant food product includes at least one edible fruit or vegetable plant source and at least one protein source mixed with the edible plant source. The protein and plant product is in a squeezable form for consumption directly from a pouch.

Exemplary embodiments overcome such problems and are directed to a combined protein and plant food product or a combined protein, plant, and grain product, and methods of making the same, that is in a squeezable fluid, i.e., in a gelled or liquid (i.e. smoothie or pureed) form that may be consumed directly from a pouch, in which the product is stored and sold as a shelf-stable item.

Among the advantages of exemplary embodiments is that methods described herein produce a comestible product including a combination of fruit-rich or vegetable-rich ingredients and protein-rich ingredients. Despite the combination of protein-rich ingredients with the fruit-rich and/or vegetable-rich ingredients in an acidic environment, exemplary embodiments exhibit limited, controlled denaturing of the protein-rich ingredients.

Another advantage is that the methods produce shelf-stable fruit and protein products, with or without grain inclusions, at ambient temperatures.

Another advantage is that at least three-fourths of a serving of fruit may be achieved in combination with enough grain so that the product is also considered to be whole grain.

A further advantage is that the methods provide heating of a fruit and protein mixture without significant denaturing of the protein ingredients such that any formed aggregates are stable, build viscosity, and do not lose water over the shelf life of the fruit and protein product. Any formed aggregates are preferably smaller than a predetermined aggregate size to prevent a gritty or chalky texture in the fruit and protein mixture.

A yet further advantage is that the methods provide viscosity control and viscosity build by changes to the protein and pectin ingredients without including other agents such as starches or other texturing ingredients.

Other features and advantages of the present invention will be apparent from the following more detailed description of exemplary embodiments that illustrate, by way of example, the principles of the invention.

### BRIEF DESCRIPTION OF THE DRAWINGS

FIG. 1 illustrates the effect of seeding on protein aggregate particle size in embodiments of the present disclosure.

FIG. 2 illustrates the effect of seeding on viscosity in embodiments of the present disclosure.

FIG. 3 illustrates the effect of viscosity on satiety in embodiments of the present disclosure.

Wherever possible, the same reference numbers will be used throughout the drawings to represent the same parts.

### DETAILED DESCRIPTION OF EXEMPLARY EMBODIMENTS

Exemplary embodiments are directed to combined protein and plant food products in a squeezable or drinkable form. Such comestibles provide both fruit/vegetable and protein benefits in a single serving without the negative effects of combined acid and heat exposure on protein. While primarily subsequently described with respect to fruits, it will be appreciated that vegetables may also be used alone or in combination with fruits, and thus any edible part of the plant may be used in combination with protein to form exemplary embodiments of the invention.

Accordingly, embodiments of the present disclosure, in comparison to methods and snacks not using one or more of the features disclosed herein, combine incompatible fruit and protein systems, provide a shelf-stable fruit and protein product, reduce denaturing of protein in a fruit and protein mixture, or a combination thereof.

Exemplary embodiments are directed to great-tasting portable products in pouches that combine both protein and fruit. There are three different fluid forms that have been identified including a gel or other non-Newtonian fluid format (i.e., a thixotropic fluid), a smoothie, and a puree, all of which may be stored in, and subsequently consumed directly from, a pouch.

In some embodiments, the product may serve as a smoothie base to be combined with only ice and fruit juice to form a fruit smoothie. In some embodiments, the smoothie base may be combined with ice, fruit juice, and one or more dairy products, which may include, but are not limited to yogurt, milk, and a combination thereof, to form a fruit smoothie.

Products in accord with exemplary embodiments preferably deliver an excellent source of protein with 5 to 10 or 15 g of protein per 4.2-ounce (119 g) serving. This translates to up to 10% by weight or more of the product being formulated with a functional protein ingredient.

Proteins denature rapidly in the high-acid environment used for hot-filling to form shelf-stable liquids and/or when used in combination with plant parts such as fruits which are high in acid. Exemplary embodiments preferably contain fruit solids and are preferably at least 14% by weight fruit purees and/or crushed fruit. In addition, grains are optionally included, preferably in amounts of at least 8% by weight, such that the product is also whole grain.

The product is manufactured by separately hydrating each of the pectin and the protein, then combining the two hydrates, followed by acidification and homogenization to maintain stability and limit the size of aggregates in the final product. Preferably, other ingredients desirable for use in the formulation are added subsequent to homogenization, after which the product is hot-filled into pouches or another container from which it may later be consumed. Methods of manufacturing the products described herein involve hydrating a high-acid compatible stabilizer, such as a high-methoxyl pectin, adding to a hydrated protein, and mixing gently. This combined hydrate is the base for the product and is gently mixed until well blended, then acidified and homogenized. The fruit and other ingredients are then gently folded to the mix. The pH is checked to make sure the mixture has a pH at or below 4.2 to allow for hot filling into a pouch, typically sized for a single serving, and any additional pH adjustments may then be made.

The pectin hydrate is made by mixing pectin with hot water, typically at a temperature greater than about 160° F. (71° C.) and preferably between about 160° F. and about 190° F. (71° C. and 88° C.). The amount of pectin depends on several factors but primarily depends on the desired viscosity of the final product as well as what types and in what form fruits (e.g. puree, juice, crushed) are added, which will naturally introduce additional pectin into the product. However, pectin is typically added in forming the initial hydrate so that it is between about 0.25 and about 1.0% by weight, typically between about 0.4 and about 0.8% by weight of the final product. The pectin is preferably high-methoxyl pectin, because high-methoxyl pectin tends to give more control over viscosity, particularly where lower viscosities are desired, than low-methoxyl pectin, although both high- and low-methoxyl pectins may be used, as well as various combinations. The pectin is pre-hydrated by combining with an aqueous liquid prior to combination with the protein. While water alone is typically preferred as the aqueous liquid, it is not necessary and other high-water content fluids, such as fruit juice may optionally be employed. The pH of the pectin hydrate is typically about 3.9 to about 4.0.

Separately, the protein is pre-hydrated prior to combination with the pectin. The protein is generally added as a protein concentrate (at least 80% wt protein) or protein isolate (at least 90% wt protein), with a preference for protein sources that are at least 85% by weight protein. In some embodiments, the protein source is a plant. In other embodiments, the protein source is a dairy protein source. In other embodiments, the protein source may be a meat protein source. Exemplary protein sources include soy, pea, dairy, whey, canola, rice, lentil, algae, or combinations thereof and a currently preferred protein source is whey protein isolate, such as those available from Hilmar Ingredients of Hilmar, Calif.

The protein is preferably hydrated with water. The amount of protein is such that a single 4.2-ounce (119 g) serving of the product preferably delivers 5 to 10 g or more of protein and thus is considered a high-protein product. In some embodiments, the product is about 5% to about 15% by weight protein, typically between about 5.5% and about 10% by weight protein. In some embodiments, yogurt may be added to the protein hydrate for additional protein and/or flavor and the yogurt may be Greek yogurt. If added, the yogurt may be present up to about 5% by weight or more of the final product.

After the pectin and protein have each been hydrated, the two are combined, with the pectin hydrate typically added to the protein hydrate to form a combined hydrate. The combined hydrate is typically in the range of 70 to 90% by weight protein hydrate and 10 to 30% by weight of the pectin hydrate. The protein may be either pre-acidified or not pre-acidified. If the protein is not pre-acidified, since the protein hydrate is present in greater amounts and has a pH typically around 6 to 6.2, it is ordinarily necessary to acidify the protein/pectin combined hydrate base, which may be achieved by adding citric acid or another suitable acid. The combined hydrate base is typically acidified as needed to a pH of 4.2 to 4.4 and is then homogenized. If the protein is pre-acidified, the protein hydrate may have a pH as low as 3.5 and typically provides the combined hydrate base with a pH in the range of 3.7 to 4.2 after mixing, so that further acidification is not needed. Homogenization typically takes place at room temperature, although higher and lower temperatures may also be suitable.

Additional ingredients may then be combined with the homogenized combined hydrate base to achieve the desired overall texture, flavor, and other characteristics, with the homogenized protein/pectin combined hydrate base present between about 30% and about 60% by weight of the final product formulation, typically between about 40% and about 55% by weight. In some embodiments, the additional ingredients may be added, in part, to manipulate the viscosity of the product for texture. The additional ingredients are preferably added after homogenization, although it will be appreciated that some or all of the additional ingredients may still be added first, typically except for pieces of fruit, grains, or other solid bits which, would tend to interfere with homogenization and are preferably added subsequent to homogenization.

In some embodiments, at least one edible plant source is added to the homogenized protein/pectin combined hydrate base, In some embodiments, the edible plant source is at least one fruit juice concentrate, at least one vegetable juice concentrate, fruit bits, vegetable bits, at least one crushed fruit, at least one crushed vegetable, at least one fruit puree, at least one vegetable puree, or a combination thereof.

Additional ingredients may include one or more sweeteners, which may be present up to about 10% by weight. Any sweetener or combination of sweeteners may be used, including high-intensity sweeteners, although natural sweeteners such as honey, agave, or stevia, for example, may be preferred. High-intensity sweeteners may include, but are not limited to, saccharin, aspartame, acesulfame potassium, sucralose, neotame, advantame, or combinations thereof.

Other additional ingredients may include a fruit component, which may include one or more combinations of fruit juice, fruit juice concentrate, fruit puree, and/or crushed fruit or other minced or small fruit pieces. The fruit component may be up to about 30% by weight or more of the final product formulation, which is preferably at least 14% by weight fruit puree, and/or crushed fruit or other minced or small fruit pieces.

Natural and/or artificial flavorings may also be added, typically up to about 3.5% by weight, along with vitamins and/or minerals. The natural and/or artificial flavorings may include one or more sourness-masking agents to mask the sourness from one or more of the fruit ingredients. In some embodiments, the sourness-masking agent includes salt.

Oral processing generally refers to the amount of time a food product is manipulated in the mouth prior to swallowing, generally in relation to a product such as water, which is merely swallowed. Oral processing may be important to satiety, with an increase in viscosity and/or texture tending to increase oral processing and satiety. In order to increase oral processing without providing an unpleasant experience, the product preferably has a viscosity greater than the viscosity of water but significantly less than the viscosity of a paste. In some embodiments, the combined protein and plant food product has a consistency in the range of 2 to 25 cm, alternatively in the range of 3 to 25 cm, alternatively in the range of 3 to 15 cm, alternatively in the range of 5 to 12 cm, or an range or sub-range therebetween, as measured by a Bostwick Consistometer. In some embodiments, a relatively high viscosity alone is sufficient to provide the increased oral processing. In other embodiments, particulates in a relatively low viscosity fluid, such as, for example, one or more forms of grains, provide the increased oral processing.

Two processes have been used to control the protein aggregation and, in turn, the viscosity and texture of protein-fruit pouches. These processes include initial recirculation of heat-treated material and controlling the amount of transfer of aggregated material (“seed”) to obtain the viscosity in a desired range. In some embodiments, a viscosity build to increase oral processing is achieved from manipulation of the protein component and/or the pectin component without any unpleasant curdling, graininess, or chalkiness and without the inclusion of any starches or other texturing ingredients in the product. In some embodiments, a predetermined desired viscosity build is achieved by the selected amount, type, and processing of the pectin component and the protein component. In some embodiments, the viscosity build is achieved while keeping the average protein aggregate particle size below a predetermined value. In some embodiments, the predetermined value is in the range of 10 to 15 micrometers (μm), about 10 μm, or any value, range, or sub-range therebetween.

In some embodiments, a predetermined portion of the combined hydrate output is subjected to additional heating and recirculated back to the combined hydrate mixing unit or a portion of the combined protein and plant food product output is subjected to additional heating and recirculated back to the combined protein and plant mixing unit to increase residence time and increase viscosity build. In some embodiments, up to 20% of the output may be additionally heated and recirculated back to the protein hydration unit. Increasing the time and temperature of the additional heating and increasing the percentage of recirculation tend to increase the average protein aggregate particle size and the viscosity build up to a certain value, beyond which additional heating and/or recirculation may decrease the viscosity.

In other embodiments, viscosity build may be achieved without recirculation. In some such embodiments, the viscosity build may be achieved by seeding with a predetermined composition such as one having a predetermined average protein aggregate particle size.

Viscosity and texture development were investigated for a protein-fruit pouch system. Based on fundamental research including time-temperature rheology and fluorescent optical microscopy, it was determined that the viscosity and texture liking for protein-fruit pouches follow a second-order curve, with time-temperature and recirculation-driven protein aggregation. If the time-temperature effect and recirculation effect are insufficient, then protein aggregation is limited, which results in a runny product with low viscosity. An intermediate range of acceptable time-temperature/recirculation conditions, which may vary with flavor, results in a desirable range of viscosity and an acceptable texture. Further thermal processing or recirculation beyond this acceptable range, however, may lead to formation of large protein aggregates, which may give rise to sensory perceptions of chalkiness or grittiness along with a decreasing viscosity. Going even further with thermal treatment may lead to conditions of thermal abuse, resulting in curdling-type effects and a further loss in viscosity as a result of a drop in the water-holding capacity of the matrix evident by visual syneresis.

Protein aggregation was measured by a laser diffraction technique with an LA-930 model particle size analyzer from Horiba Scientific of Kyoto, Japan, and a parameter called “protein aggregation factor” defined changes in protein aggregation, which were correlated with viscosity and sensory attributes. As used herein, the protein aggregation factor refers to the ratio of protein aggregates in the range of 10 to 50 μm in size to protein aggregates less than 10 μm in size, multiplied by five. The protein aggregation factor quantified the conversion of low particle size fractions to higher particle size fractions. Depending on fruit variations and processing conditions, the protein aggregation factor was measured to be in a range of 1 to 25, where a protein aggregation factor of 15 or higher generally corresponded to grittiness in the protein-fruit pouch matrix.

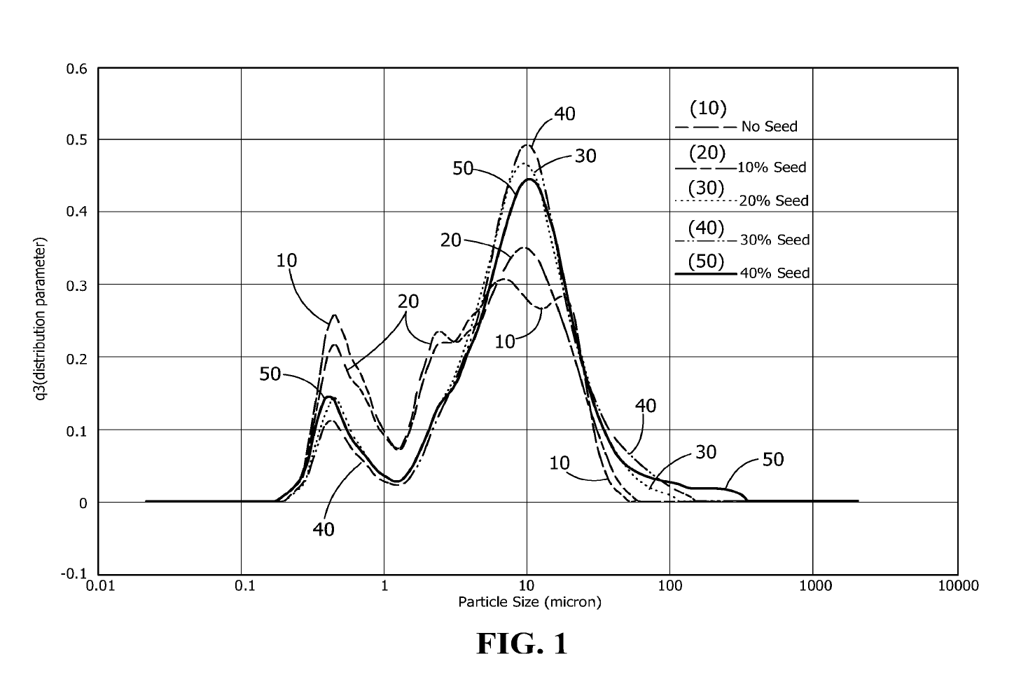

FIG. 1 shows the effect of seed percentage on the particle size distribution of protein aggregates in a protein-pectin system. The distribution is generally bimodal, with one peak around 0.5 μm and a second peak around 10 μm. A sample with no recirculation seeding 10, a 10% seeding sample 20, a 20% seeding sample 30, a 30% seeding sample 40, and a 40% seeding sample 50 were tested. All samples received a similar thermal treatment. The mean diameter was 5.3, 6.7, 10.5, 11.9, and 11.7 μm for 0, 10, 20, 30, and 40% seeding, respectively. As FIG. 1 shows, the 0.5 μm peak decreased significantly and the 10 μm increased significantly upon increasing the seeding from 0 to 10 to 20%, indicating an increase in protein aggregate size. Further increasing of the seeding percentage had a relatively small effect on the two peaks.

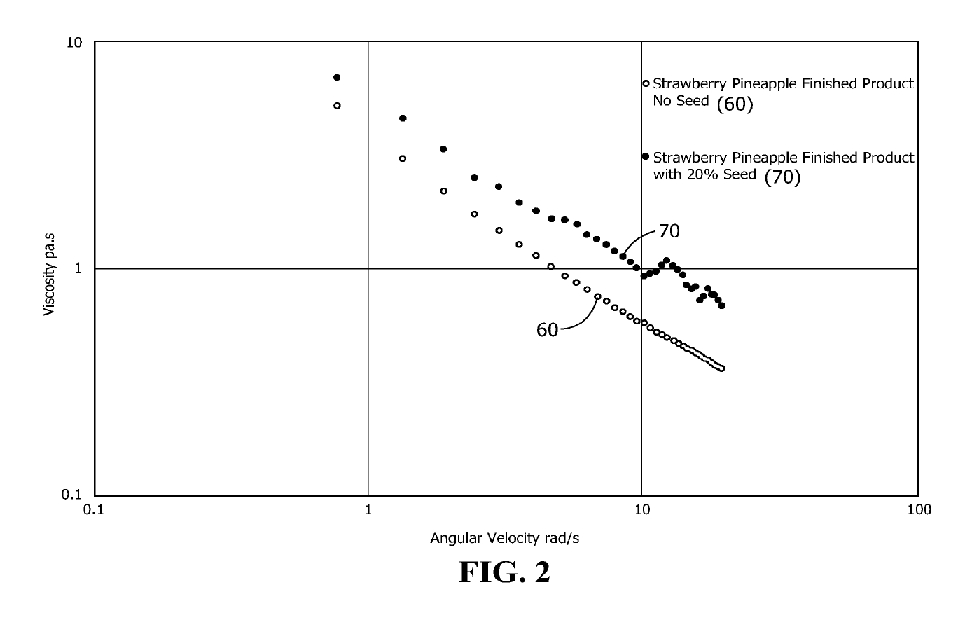

FIG. 2 shows that a strawberry pineapple combined protein and plant food product with no seeding 60 had a lower viscosity than a 20%-seeded strawberry pineapple combined protein and plant food product 70. Thus, increasing the seed percentage from 0 to 20% increased both the average protein aggregate size and the viscosity of a strawberry pineapple combined protein and plant food product. The finished products received similar thermal treatments under controlled time-temperature conditions. The viscosities were measured at about 25° C. (77° F.) using an AR-G2 rheometer from TA Instruments of New Castle, Del.

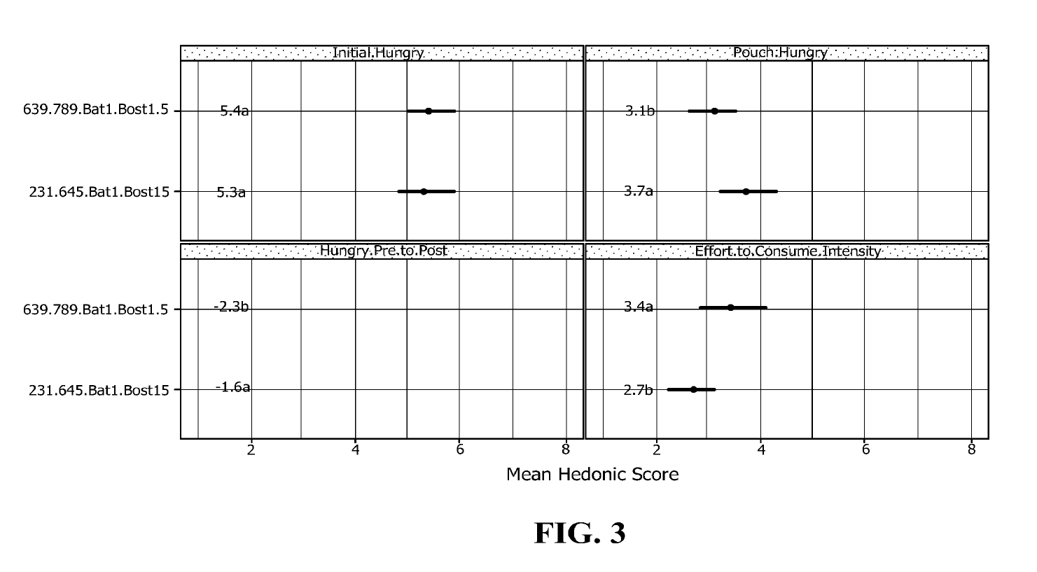

FIG. 3 shows that thicker samples having a lower Bostwick consistency value (1.5 cm versus 15 cm) and a higher viscosity lead to more oral processing and less hunger after consumption. Scoring was based on self-reporting by consumers based on the 9-point hedonic scale. Consumers in the two groups had similar hunger levels (5.4 versus 5.3) prior to consumption. The consumers reported more effort (3.4 versus 2.7) to consume the thicker sample. Although a decrease in hunger (5.4 to 3.1 versus 5.3 to 3.7) was observed after consumption of both samples, the decrease in hunger was more intense for the thicker sample (−2.3) than the thinner sample (−1.6).

Generally, FIG. 1, FIG. 2, and FIG. 3 show that seeding up to about 20% increases protein aggregate size, viscosity, and satiety in a combined protein and plant food product.

Certain properties, such as solubility, of meat proteins, dairy proteins, and plant proteins may differ significantly, such that the hydration and viscosity build procedures may vary significantly depending on the protein source used to make the product to get a viscosity and a texture in the final product within a predetermined range.

In one embodiment, the product has a composition as shown in Table 1, in which percentages are weight percentages of the final product.

TABLE 1
Preferred protein and plant product compositions

| Ingredient | Amount |
|---|---|
| Water (~70° F.) - via protein hydrate | 25-30 |
| Protein - via protein hydrate | 0.1-15 |
| Greek yogurt - via protein hydrate | 0-15 |
| Pectin - via pectin hydrate | 0.2-1.0 |
| Water (~160 to 190° F.) - via pectin hydrate | 7-10 |
| Frozen Crushed Fruit | 7-11 |
| Fruit Puree | 7-11 |
| Dried Fruit Bits | 0-2 |
| Honey | 4-7 |
| Flavorings | 1-3.5 |
| Fruit Juice Concentrate | 9-14 |
| Additional Water | 0-16 |
| Citric Acid (50:50) | 0-3 |

In some embodiments, the product also includes a fiber element, such as inulin or other soluble fibers, such as those available from Ingredion Inc. of Westchester, Ill., available under the tradename Nutriose. Fiber may be up to about 10% by weight of the final product. In still other embodiments, up to about 3.5% by weight of a liquid fat (e.g. coconut oil, olive oil, etc.) may be added.

In some embodiments, one or more particulate ingredients, preferably in the form of grains or seeds, may be added following homogenization to deliver a food product that also delivers the benefits of those ingredients, including whole grains in some embodiments. Grains and/or seeds may be employed up to about 10% by weight of the final product. Exemplary grains include oats, chia, and quinoa. In some embodiments, satiety may be increased by adding one or more grains following homogenization. In some embodiments, the satiety-increasing addition may be oats. Other grains may additionally or alternatively be employed, with a preference in some cases for gluten-free ingredients. Embodiments that employ the addition of one or more grains introduce additional challenges to manufacture to ensure that the grains are compatible with the acidified protein/fruit base. In order to overcome this problem, for exemplary embodiments employing grains, the grains are soaked in a diluted acid and then strained. The strained, acidified grain particulates are then added to the protein/fruit base and mixed.

The introduction of fruit bits, grains and/or other solid elements into the product is desirable as it is believed to increase feelings of satiation. Oats may be a preferred grain to increase satiety from the product.

It will be appreciated that in addition to the above-mentioned ingredients, water and/or additional acid to adjust the final viscosity and/or pH may also be added, as the pH of the product prior to final processing and hot filling is preferably in the range of about 3.6 to about 4.3, more preferably about 3.9 to about 4.0. Thus, after the fruit and other ingredients are added to the homogenized protein/pectin hydrate, the final product is formed by additional blending, any final pH adjustment, and pasteurization as may be necessary for the hot filling process, followed by filling of containers and subsequent cooling, upon which the product may be distributed for consumption. In some embodiments, however, other aseptic processing may be used to avoid a hot filling process for filling the pouches with the combined protein and plant food product.

In addition to heat and pH, the type of fruit and acid may also impact stability. Acid combinations, such as malic acid and citric acid blends, tend to provide better stability and flavor than individual acids. Other acids that provide greater pH reduction with lesser amounts, such as phosphoric acid, may be employed in some cases to reduce harshness of flavor. Other acids may include ascorbic acid and blends of any of citric, malic, ascorbic, and phosphoric acids, for example. As with the pectin, the type of acid may affect the appearance, texture, and eating characteristics of the finished product.

It may be possible that the fruit components also impact stability. For example, white grape juice with higher tannins may affect protein stability compared to pear juice concentrate, such that the pear juice concentrate may provide a more stable product.

The application is further described with respect to the following examples which are presented by way of further exemplification, and not limitation.

### EXAMPLES

### Example 1

A protein/pectin base hydrate was prepared by first mixing 55 parts by weight of whey protein isolate (Hilmar Ingredients) with 302 parts by weight of water, along with a small amount (0.05% by weight) of an anti-foaming agent, to form a protein hydrate. Separately, 4 parts by weight of high-methoxyl pectin (GENU® 100 H, CP Kelco ApS Corp., Lille Skensved, Denmark) was mixed with 75 parts by weight of water at an elevated temperature (160 to 190° F.) to form a pectin hydrate.

The pectin hydrate was added to the protein hydrate, to form a combined hydrate that was adjusted to a pH of 4.4 with citric acid, and then the base hydrate was homogenized.

### Example 2

A protein/pectin base hydrate was prepared by first mixing about 60 parts by weight of whey protein isolate (Hilmar Ingredients) with about 332 parts by weight of water, again with 0.05% by weight of an anti-foaming agent, to form a protein hydrate. Separately, about 10 parts by weight of high-methoxyl pectin (GENU 100 H) was mixed with about 145 parts by weight of water at an elevated temperature (in the range of 160 to 190° F.) to form a pectin hydrate.

As in Example 1, the pectin hydrate was added to the protein hydrate, to form a combined hydrate that was adjusted to a pH of 4.4 with citric acid, and then the combined hydrate was homogenized.

### Example 3

The base hydrate of Example 1 was used to formulate a pouched fluid fruit product formed from the components of Table 2.

TABLE 2
Components of Example 3

| Ingredient | Wt. % |
|---|---|
| Protein/Pectin Base of Ex. 1 | 48.3% |
| Honey | 6% |
| Fruit juice concentrate | 9.6% |
| Frozen crushed fruit | 6.0% |
| Fruit bits | 0.5% |
| Fruit puree | 16% |
| Flavorings | 1.1% |
| Additional water | 10.1% |
| Citric acid 50:50 diluted with | 2.4% |
| water | |

All ingredients except for the citric acid/water were mixed together, and the pH was adjusted to about 3.95 by addition of the citric acid/water, followed by pasteurization by heating at about 190° F. (88° C.) for about 2 minutes. The final product was then poured into pouches and seated, followed by additional pasteurization in the pouch.

### Example 4

The base of Example 1 was used to formulate a pouched fluid fruit product formed from the components of Table 3.

TABLE 3
Components of Example 4

| Ingredient | Wt. % |
|---|---|
| Protein/Pectin Base of Ex. 1 | 48.5% |
| Honey | 6% |
| Fruit juice concentrate | 9.6% |
| Frozen crushed fruit | 7.7% |
| Fruit bits | 0.5% |
| Fruit puree | 11% |
| Flavorings | 1.4% |
| Additional water | 12.9% |
| Citric acid 50:50 diluted with | 2.4% |
| water | |

All ingredients except for the citric acid/water were mixed together, and the pH was adjusted to about 3.95 by addition of the citric acid/water, followed by pasteurization by heating at about 190° F. (88° C.) for about 2 minutes. The final product was then poured into pouches and seated, followed by additional pasteurization in the pouch.

### Example 5

The base of Example 2 was used to formulate a strawberry pineapple flavored pouched fluid fruit product formed from the components of Table 4.

TABLE 4
Components of Example 5

| Ingredient | Wt. % |
|---|---|
| Protein/Pectin Base of Ex. 2 | 48.5% |
| Honey | 6% |
| Fruit juice concentrate | 12.6% |
| Frozen crushed fruit | 11.7% |
| Fruit puree | 7% |
| Flavorings | 1.6% |
| Additional water | 10.2% |
| Citric acid 50:50 diluted with | 2.4% |
| water | |

All ingredients except for the citric acid/water were mixed together, and the pH was adjusted to about 3.95 by addition of the citric acid/water, followed by pasteurization by heating at about 190° F. (88° C.) for about 2 minutes. The final product was then poured into pouches and seated, followed by additional pasteurization in the pouch.

### Example 6

The base of Example 2 was used to formulate a mango flavored pouched fluid fruit product formed from the components of Table 5.

TABLE 5
Components of Example 6

| Ingredient | Wt. % |
|---|---|
| Protein/Pectin Base of Ex. 2 | 43.6% |
| Honey | 6% |
| Fruit juice concentrate | 12.6% |
| Frozen crushed fruit | 10.7% |
| Fruit puree | 7% |
| Flavorings | 1.4% |
| Additional water | 16.3% |
| Citric acid 50:50 diluted with | 2.4% |
| water | |

All ingredients except for the citric acid/water were mixed together, and the pH was adjusted to about 3.95 by addition of the citric acid/water, followed by pasteurization by heating at about 190° F. (88° C.) for about 2 minutes. The final product was then poured into pouches and seated, followed by additional pasteurization in the pouch.

### Example 7

The product of Example 7 was prepared by adding 10% by weight steel cut oats to the product of Example 6 prior to final processing, with the overall water content adjusted accordingly.

### Example 8

A protein smoothie having the overall formulation shown in Table 6 was formulated as described.

TABLE 6
Formulation of Example 8

| Ingredient | Wt. % |
|---|---|
| Water for protein base | 44.7 |
| Protein (Protein 9400 from | 10 |
| Hilmar) | |
| Sugar | 9.7 |
| Fruit juice concentrate | 17.8 |
| Malic/Citric acid blend (30/70) | 2 |
| Flavorings | 0.6 |
| Sodium phosphate | 0.4 |
| Additional water | 14 |
| Pectin | 0.8 |

The sugar and pectin were dry blended, added to water at about 165° F. (74° C.), and mixed for about 20 minutes. Additional water was then added to bring the temperature below 90° F. (32° C.). The protein was then added followed by mixing for about 20 minutes, followed by the addition of the sodium phosphate and mixing for another 10 minutes. Then the juice concentrates were added and mixed for 15 minutes. The pH was checked, and flavorings were added with the acid to achieve a pH of about 3.9. The product was then homogenized at room temperature and processed for filling.

### Example 9

A clear protein gel having the overall formulation shown in Table 7 was formulated as described.

TABLE 7
Formulation of Example 9

| Ingredient | Wt. % |
|---|---|
| Water | 58.3 |
| Protein (Protein 9420 from | 10 |
| Hilmar) | |
| Sugar | 9.0 |
| Fruit juice concentrate | 18.6 |
| Ascorbic/citric acid blend (30/70) | 3.3 |
| Flavorings | 0.8 |

The protein was added to water at room temperature containing a trace amount of anti-foaming agent and hydrated under mixing for 25 minutes. The sugar was then added, followed by the fruit juice concentrates and additives, all of which were gently folded in. The pH was checked, and the acid was added to achieve a pH of about 3.4. The product was then homogenized at room temperature and then processed for filling.

### Examples 10-16

Additional example formulations are provided in Table 8 in which all amounts are in percent by weight.

TABLE 8
Additional Formulations

| Ingredients | Ex. 10 | Ex. 11 | Ex. 12 | Ex. 13 | Ex. 14 | Ex. 15 | Ex. 16 |
|---|---|---|---|---|---|---|---|
| Water | 54 | 51.5 | 44 | 49.8 | 44 | 44.5 | 44.5 |
| Fruit Juice | 12.1 | 12.1 | 12.1 | 12.1 | 12.1 | 12.1 | 12.1 |
| Concentrate | | | | | | | |
| Frozen fruit pieces | 10.7 | 10.7 | 10.7 | 10.7 | 10.7 | 10.7 | 10.7 |
| Fruit Puree | 7.5 | 7.5 | 7.5 | 7.5 | 7.5 | 7.5 | 7.5 |
| Concentrate | | | | | | | |
| Flavorings | 1.4 | 1.4 | 1.4 | 1.4 | 1.4 | 1.4 | 1.4 |
| Steel Cut Oats | | | 10 | | | | |
| Sugar | | | | | | 9.5 | |
| Honey | 6 | 6 | 6 | 6 | 6 | 6 | 6 |
| Whey Protein | 5.5 | 8.0 | 5.5 | 5.5 | 5.5 | 5.5 | 5.5 |
| (Hilmar 9000) | | | | | | | |
| Citric Acid | 2.4 | 2.4 | 2.4 | 2.4 | 2.4 | 2.4 | 2.4 |
| Pectin | 0.4 | 0.4 | 0.4 | 0.4 | 0.4 | 0.4 | 0.4 |
| (Genu YM 100H) | | | | | | | |
| Soluble Fiber | | | | | 10 | | |
| (Nutriose FM06) | | | | | | | |
| Coconut Oil 76, AAK | | | | 4.2 | | | |
| Maltodextrin | | | | | | | 9.5 |
| (Star Dri 100) | | | | | | | |

In each case, the pectin was first hydrated in water at a temperature in the range of 160 to 190° F. (71° C. to 88° C.). Second, the protein was separately hydrated, to which the other ingredients except for the flavorings, acid, and fruit pieces were added. The ingredients were then homogenized and the flavorings and fruit pieces were thereafter added, along with acid and additional water to achieve a pH of about 4.

### Example 17

A protein/pectin base hydrate was prepared by first mixing 55 parts by weight of canola protein with 302 parts by weight of water, along with a small amount (1 part) of an anti-foaming agent, to form a protein hydrate. Separately, 4 parts by weight of high-methoxyl pectin (GENU® 100 H) was mixed with 75 parts by weight of water at an elevated temperature (160 to 190° F.) to form a pectin hydrate.

The pectin hydrate was added to the protein hydrate at a ratio of about 18:82, to form a base hydrate that was adjusted to a pH of 4.3 to 4.4 with citric acid, and then the base hydrate was homogenized.

### Example 18

The base hydrate of Example 17 was used to formulate a mango orange flavored pouched fluid fruit product formed from the components of Table 4.

TABLE 9
Components of Example 18

| Ingredient | Wt. % |
|---|---|
| Protein/Pectin Base of Ex. 17 | 43.7% |
| Honey | 6% |
| Pear juice concentrate | 9.6% |
| Frozen crushed mango | 8.7% |
| Mango puree | 6.5% |
| Orange juice concentrate | 2.5% |
| Orange puree | 1.0% |
| Flavorings | 1.4% |
| Additional water | 18.2% |
| Citric acid 50:50 diluted with | 2.4% |
| water | |

All ingredients except for the citric acid/water were mixed together, and the pH was adjusted to about 3.9 by addition of the citric acid/water, followed by pasteurization by heating at about 190° F. (88° C.) for about 2 minutes. The final product was then poured into pouches and seated, followed by additional pasteurization in the pouch.

The strawberry pineapple flavored product of Example 5 and a variation of the mango flavored product of Example 6 (using half the amount of pectin) were the subject of additional testing and characterization for rheology characteristics, the results of which illustrated that the level of pectin and the type of fruit affects viscosity and thickness of the final product. The strawberry pineapple flavored product and the mango flavored product both showed shear thinning properties, with the strawberry pineapple flavored product having a slightly higher viscosity. The shear stress and shear rate data fit better to a Casson model than to a Bingham model. A Casson model rheology map placed both the strawberry pineapple flavored product and the mango flavored product in the thick/structured quadrant, with the strawberry pineapple flavored product being thicker and more structured than the mango flavored product.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of manufacturing a combined protein and plant food product comprising the steps of:
hydrating at least one pectin source to form a pectin hydrate;
hydrating at least one protein source to form a protein hydrate;
mixing the pectin hydrate with the protein hydrate to form a combined hydrate;
adjusting, if necessary, a pH of the combined hydrate to the range of 3.7 to 4.4;
homogenizing the combined hydrate to form a homogenized hydrate; and
adding at least one edible plant source to the homogenized hydrate to form the combined protein and plant food product.

2. The method of claim 1, wherein the at least one edible plant source is selected from the group consisting of at least one fruit juice concentrate, at least one vegetable juice concentrate, fruit bits, vegetable bits, at least one crushed fruit, at least one crushed vegetable, at least one fruit puree, at least one vegetable puree, and combinations thereof.

3. The method of claim 1, wherein the at least one protein source is selected from the group consisting of a soy protein, a pea protein, a dairy protein, a whey protein, a canola protein, a rice protein, a lentil protein, an algae protein, and combinations thereof.

4. The method of claim 1, wherein the at least one protein source is selected from the group consisting of a protein concentrate and a protein isolate.

5. The method of claim 1, wherein the combined hydrate comprises, by weight, 70 to 90% of the protein hydrate and 10 to 30% of the pectin hydrate.

6. The method of claim 1 further comprising adding to the combined protein and plant food product at least one particulate ingredient selected from the group consisting of at least one grain, at least one seed, oats, quinoa, chia seeds, and combinations thereof.

7. The method of claim 6, wherein the at least one particulate ingredient is selected to increase oral processing and satiety for the combined protein and plant food product.

8. The method of claim 1, wherein the combined protein and plant food product comprises 30 to 60% of the combined hydrate, by weight.

9. The method of claim 1 further comprising adjusting a pH of the combined protein and plant food product to a value in the range of 3.6 to 4.4.

10. The method of claim 1 further comprising homogenizing the combined protein and plant food product.

11. The method of claim 1 further comprising thermally treating and recirculating a portion of the combined hydrate to build a viscosity in the combined protein and plant food product.

12. The method of claim 1 further comprising thermally treating and recirculating a portion of the combined protein and plant food product to build a viscosity in the combined protein and plant food product.

13. The method of claim 12, wherein the viscosity is selected to increase oral processing and satiety for the combined protein and plant food product.

14. The method of claim 1 further comprising aseptically filling the combined protein and plant food product into pouches.

15. A combined protein and plant food product, comprising:
at least one edible plant source selected from the group consisting of a fruit and vegetable; and
at least one protein source and at least one pectin source mixed with the edible plant source;
wherein the protein and plant product is in a squeezable or drinkable fluid form for consumption directly from a pouch.

16. (canceled)

17. (canceled)

18. The product of claim 15, wherein the at least one protein source is selected from the group consisting of a protein concentrate and a protein isolate.

19. The product of claim 15, wherein a 4.2-ounce serving of the combined protein and plant food product comprises at least 5 grams of protein from the at least one protein source.

20. (canceled)

21. (canceled)

22. The product of claim 15, wherein the protein and plant product comprises at least 14% by weight of fruit puree and crushed fruit.

23. (canceled)

24. The product of claim 15, wherein protein aggregates in the protein and plant product from the at least one protein source have an average particle size less than 15 micrometers.

25. (canceled)

26. The product of claim 15, wherein the combined protein and plant food product comprises, by weight, 15 to 30% protein, 0.2 to 1% pectin, 7 to 11% crushed fruit or vegetable, 7 to 11% fruit or vegetable puree, 0 to 2% dried fruit or vegetable bits, 4 to 7% honey, 1 to 3.5% flavoring, 9 to 14% fruit or vegetable juice concentrate, and water.
